(19) United States
(12) Patent Application Publication
(10) Pub. No.: US 2011/0259205 A1
(43) Pub. Date: Oct. 27, 2011

(54) Beverage Pod

(76) Inventor: Kevin SJ. Delorme, North Bay (CA)

(21) Appl. No.: 12/767,478

(22) Filed: Apr. 26, 2010

(51) Int. Cl. A47J 31/06

(52) U.S. Cl. 99/299

(57) ABSTRACT

A disposable single-cup beverage pod designed for use in single-cup brewing systems, and composed of materials that are environmentally-friendly. Current disposable single-cup beverage pods are composed of unrecyclable plastic materials, thus raising environmental concerns. Therefore there is a real need for a disposable single-cup beverage pod composed of environmentally-friendly materials and constructed with advancements that allow variations in brewing.

### FIELD OF THE PRESENT INVENTION

The present invention relates to a beverage pod, and more particularly, to disposable single-cup beverage pods designed for use in single-cup brewing systems. Current disposable single-cup beverage pods are composed of unrecyclable plastic materials, thus raising environmental concerns. Therefore there is a real need for a disposable single-cup beverage pod that is environmentally-friendly. In addition, the present invention advances beverage pod design in terms of brewing ability.

### BACKGROUND OF THE PRESENT INVENTION

The present invention is an environmentally-friendly single-cup beverage pod for use in a conventional single-cup brewing system. The ease of using single-cup beverage pods has contributed immensely to their popularity, yet this ease of use has created an environmental problem. It is estimated that 2.5 million single-cup beverage pods containing plastic materials are put into the trash each day, and these pods are neither recyclable nor biodegradable.

The single-cup beverage pod has proven to be unrecyclable for several reasons. First, the plastic materials used for the beverage pod are not recyclable. According to an article dated Jul. 6, 2009 at the Sustainable Life Media website, single-cup beverage pods in current use are composed of “petroleum based plastic, with a layer of polyethylene coating, an interior filter paper, and an aluminum foil top. It keeps the coffee fresh, but makes recycling impossible.” Second, even if the plastic used in a beverage pod was recyclable, each beverage pod would first have to be disassembled in order to recycle the plastic, a task which not all consumers are prepared to undertake. Thus it makes sense to produce a single-cup disposable beverage pod that is made of biodegradable materials.

In response to this problem, Green Mountain Coffee Roasters, Inc. (GMC), which sells a single-cup brewing system that uses disposable plastic beverage pods, has said that the invention of an environmentally-friendly single-cup beverage pod is one of the company's main goals. As a medium-term solution to the single-cup beverage pod environmental problem, GMC has invented a pod that employs a reusable screen filter. But coffee connoisseurs seem to prefer the taste of coffee brewed within a disposable pod, probably because the coffee in a disposable pod is sealed away from all air, light and moisture until the point of brewing.

U.S. Pat. No. 5,325,765 issued to John E. Sylvan et al. on Jul. 5, 1994, describes a single serve beverage filter cartridge which is made of polystyrene, ethylene vinyl alcohol and polyethylene, unlike the present invention which is made out of materials that are environmentally-friendly. Further, the construction of Sylvan et al.'s device is unlike the present invention in terms of pieces employed.

U.S. Pat. No. 5,840,189 issued to John E. Sylvan et al. on Nov. 24, 1998, describes a single serve beverage filter cartridge composed of “coextruded composite barrier sheet consisting of polystyrene, polyethelene, EVOH [Ethylene Vinyl Alcohol] and adhesive,” unlike the present invention which is made of materials that are environmentally-friendly. Further, the construction of Sylvan et al.'s device is unlike the present invention in terms of pieces employed.

U.S. Pat. No. 6,607,762 issued to Nicholas G. Lazaris on Aug. 19, 2003, is for a disposable one-cup brew basket with an outer container composed of polyethylene/EVOH/polystyrene, unlike the present invention which is made of materials that are environmentally-friendly. Further, the construction of Lazaris' device is unlike the present invention in terms of pieces employed.

U.S. Pat. No. 7,081,263 issued to Douglas A. Albrecht on Jul. 25, 2006, is for a disposable one-cup brew basket wherein the bottom and wall of the basket are made of vacuum formed high-impact polystyrene, unlike the present invention which is made of materials that are environmentally-friendly. Further, the construction of Albrecht's device is unlike the present invention in terms of pieces employed.

U.S. Pat. No. 6,658,989 issued to Richard P. Sweeney et al. on Dec. 9, 2003, is for a reusable beverage filter cartridge, unlike the present invention which is a single-use, disposable beverage filter cartridge. Further, the construction of Sweeney et al.'s device is unlike the present invention in terms of pieces employed.

U.S. Pat. No. 6,440,256 issued to Steven J. Gordon et al. on Aug. 27, 2002, is concerned in particular with forming and inserting the filter elements into the beverage cartridge, unlike the present invention which is designed to be an environmentally-friendly disposable beverage filter cartridge. Further, the construction of Gordon's device is unlike the present invention in terms of pieces employed.

U.S. Pat. No. 6,645,537 issued to Richard Sweeney et al. on Nov. 11, 2003, is primarily concerned with assembly of the beverage cartridge materials, unlike the present invention which is designed to be an environmentally-friendly disposable beverage filter cartridge. Further, the construction of Sweeney et al.'s device is unlike the present invention in terms of pieces employed.

Thus there is still a pressing need for an environmentally-friendly, disposable single-cup coffee pod such as the present invention. Addditionally, there is a need for a beverage pod that is contructed to provide the reinforcment and arrangement of pieces that allow it be environmentally-friendly. Moreover, there is a need to offer variations in pod brewing techniques compared to the single standard that is prevalent in the beverage pod industry.

### SUMMARY OF THE PRESENT INVENTION

It is an object of the present invention to provide an environmentally-friendly design for disposable single-cup beverage pods that are compatible for use with single-cup brewing systems. Single-cup beverage pods have been environmentally-unfriendly because bio-plastics (i.e., environmentally-friendly plastics) have not been able to properly seal the single-cup beverage pod's contents (coffee, filter, oxygen, etc.) and also withstand the high heat that the brewing process requires.

The present invention is a single-cup disposable beverage pod with an outer shell composed of durable paper with a wax coating, unlike previous inventions that used plasticene materials such as polyethylene and polystyrene. Further, the present invention provides a sealed bottom that is attached to sidewalls without leakage. Moreover, the present invention provides for rearrangement of the brewing components to offer variation in brewing—and the variation is possible because the construction of the present invention is different than that of known beverage pods.

### BRIEF DESCRIPTION OF THE DRAWINGS

FIG. 1 shows a side cutaway view of the preferred embodiment of the present invention, with the filter disposed in fixed communication with the side wall.

FIG. 2 shows a side cutaway view of another embodiment of the present invention, with the filter disposed in fixed communication with the bottom wall.

### DETAILED DESCRIPTION OF THE PRESENT INVENTION

The present invention is an environmentally-friendly beverage pod (5) designed to fit pre-existing single-cup beverage systems. There are numerous components utilized in the construction of the beverage pod (5), among them the outer shell or cylinder, herein referred to as the side wall (10); the rim (15) of the side wall (10); the cover (30), of either conventional foil or conventional durable paper with wax coating; the bottom wall (40), also of either conventional foil or conventional durable paper with wax coating; a filter (50) disposed in fixed communication with either the side wall (10) or the bottom wall (40); and a solid beverage medium (60) disposed above the filter (50).

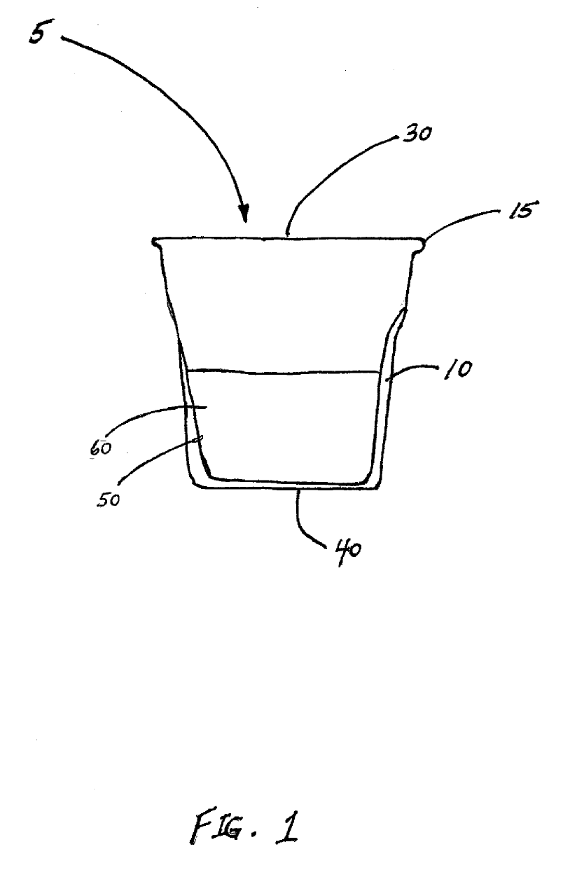

In the preferred embodiment of the present invention, as seen in FIG. 1, we see a beverage pod (5) with a side wall (10) composed of conventional durable paper with wax coating. A filter (50) is placed within the beverage pod (5), with the filter (50) disposed in fixed communication with the side wall (10) by any known means. A solid beverage medium (60) is disposed above the filter (50), with the filter (50) configured to prevent the solid beverage medium (60) from passing through the filter (50). Because of this configuration, only a resultant beverage will pass through the filter (50). Disposed at the top of the side wall (10) is the rim (15) and a cover (30) of either conventional durable paper with wax coating or conventional foil. The rim (15) is preferably needed to help seat the beverage pod (5) in a conventionally known single-cup beverage brewer. At the bottom of the side wall (10) is a bottom wall (40), also of either conventional foil or conventional durable paper with wax coating. The side wall (10) is in communication with the bottom wall (40) at a circumference of the bottom wall (40), however, in the preferred embodiment, the bottom wall (40) is not merely formed with the side wall (10) as would be a plastic cup that has a unitary side wall together with a bottom end. Rather, the preferred embodiment of the present invention provides for the bottom wall (40) to be joined but separate from the side wall (10). This separate but joined distinction regarding the bottom wall (40) and the side wall (10) is important, as will be addressed in a following paragraph.

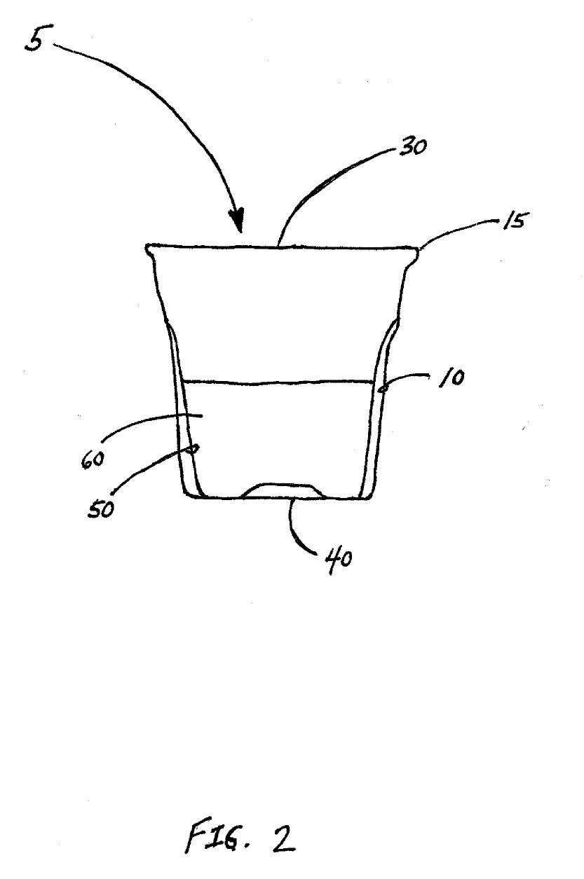

In another embodiment of the present invention, as seen in FIG. 2, a filter (50) is placed within the beverage pod (5), with the filter (50) disposed in fixed communication with the bottom wall (40) by any known means. Disposed at the top of the side wall (10) is the rim (15) and a cover (30) of either conventional durable paper with wax coating or conventional foil. The rim (15) is preferably needed to help seat the beverage pod (5) in a conventionally known single-cup beverage brewer. At the bottom of the side wall (10) is the bottom wall (40), also of either conventional foil or conventional durable paper with wax coating. As in the preferred embodiment, a solid beverage medium (60) is disposed above the filter (50), with the filter (50) configured to prevent the solid beverage medium (60) from passing through the filter (50). Because of this configuration, only a resultant beverage will pass through the filter (50). In this embodiment, the filter (50) is the only filter that is disposed in the beverage pod (5). And in terms of manufacturing, the attached but non-unitary bottom wall (40) of the present invention allows construction of the bottom wall (40) with the filter (50) attached to the bottom wall (40). Once the filter (50) has been attached to the bottom wall (40), then the bottom wall (40) is attached to the side wall (10), thus the importance of the separate but joined distinction regarding the bottom wall (40) and the side wall (10). If the bottom wall (40) was merely formed together with the side wall (10), then it would be difficult to attach the filter (50) to the bottom wall (40).

To examine how the present invention functions, the present invention should be construed as it works in communication with a conventional pre-existing single-cup beverage system. The beverage pod (5) is loaded into a conventional pre-existing single-cup beverage system that operates with a conventional probe that penetrates the cover (30) and injects hot water into the beverage pod (5) into the area bounded within the side wall (10). The hot water moves downward into the filter (50) that has the solid beverage medium (60) disposed above the filter (50). Then, the hot water continues downward where it is removed by the conventional single-cup beverage system's outlet probe that pierces the bottom wall (40). After use, the beverage pod (5) is disposed of.

Preferably, paper is used for the cover (30), side wall (10), and bottom wall (40), as well as for the filter (50), so that the present invention will be biodegradable after disposal. An advantage of the present invention is that, because the filter (50) can be attached to the side wall (10), for example, the filter (50) can be positioned low enough to allow water above the filter (50) to mix with a solid beverage medium (60) that has been placed above the filter (50). Known pods have a filter pouch that hold coffee, etc., and the filter pouch tends to be attached to the top of the pod. Thus, there is not much room for water to mix with the coffee, etc. Additionally, in the embodiment of the present invention in which the filter (50) is attached to the bottom wall (40) (see FIG. 2), nearly the entire inside of the beverage pod (5) is employed to allow water to mix with the solid beverage medium (60). Both the embodiments just described offer taste and brewing differences over known pods. Known beverage pods are restricted in that they are formed of a unitary plastic cup that merely acts as a cover for a filter pouch that has been attached to a top. Further, with the present invention, if the filter (50) is attached to the bottom wall (40), then the brewed coffee is then filtered right out of the beverage pod (5) without the need for it to come into much contact with the side wall (10). This can be important so that little or no aftertaste is imparted from the side wall (10) to the coffee.

It should be understood that the present invention is not limited solely to the embodiments described above, but to any and all embodiments within the scope of the following claims.

In summary, the present invention in the preferred embodiment is a beverage pod comprising a bottom wall, a side wall in communication with the bottom wall at a circumference of the bottom wall, a rim disposed at the top of the side wall, a cover in communication with the side wall, and a filter disposed from the side wall. The side wall, bottom wall, and cover are made of paper with a wax coating, and the bottom wall is fused to the side wall. The beverage pod contains a solid beverage medium disposed above the filter, which is configured to prevent the solid beverage medium from passing through the filter.

Furthermore, the present invention in another embodiment is a beverage pod comprising a bottom wall, a side wall in communication with the bottom wall at a circumference of the bottom wall, a rim disposed at the top of the side wall, a cover in communication with the side wall, and a filter disposed from the bottom wall. The side wall, the cover and the bottom wall are made of paper with a wax coating, and the bottom wall is fused to the side wall. The beverage pod contains a solid beverage medium disposed above the filter, which is configured to prevent the solid beverage medium from passing through the filter.

What is claimed is:

1. A beverage pod, comprising:
a bottom wall;
a side wall in communication with said bottom wall at a circumference of said bottom wall;
a rim disposed at a top of said side wall;
a cover in communication with said side wall; and
a filter disposed from said side wall.

2. The beverage pod of claim 1, wherein said side wall is paper.

3. The beverage pod of claim 1, wherein said side wall has a wax coating.

4. The beverage pod of claim 2, wherein said side wall has a wax coating.

5. The beverage pod of claim 1, further comprising a solid beverage medium disposed above said filter.

6. The beverage pod of claim 1, wherein said filter is configured to prevent said solid beverage medium from passing through said filter.

7. The beverage pod of claim 2, further comprising a solid beverage medium disposed above said filter.

8. The beverage pod of claim 3, further comprising a solid beverage medium disposed above said filter.

9. The beverage pod of claim 4, further comprising a solid beverage medium disposed above said filter; and wherein said filter is configured to prevent said solid beverage medium from passing through said filter.

10. A beverage pod, comprising:
a bottom wall;
a side wall in communication with said bottom wall at a circumference of said bottom wall;
a rim disposed at a top of said side wall;
a cover in communication with said side wall; and
a filter disposed from said bottom wall.

11. The beverage pod of claim 10, wherein said side wall is paper.

12. The beverage pod of claim 10, wherein said side wall has a wax coating.

13. The beverage pod of claim 11, wherein said side wall has a wax coating.

14. The beverage pod of claim 10, further comprising:
a solid beverage medium disposed above said filter; and
wherein said side wall is paper;
wherein said side wall has a wax coating; and
wherein said filter is configured to prevent said solid beverage medium from passing through said filter.

15. The beverage pod of claim 1, wherein said cover is paper that has a wax coating.

16. The beverage pod of claim 1, wherein said bottom wall has a wax coating.

17. The beverage pod of claim 9,
wherein said cover is paper that has a wax coating;
wherein said bottom wall has a wax coating; and
wherein said bottom wall is fused to said sidewall.

18. The beverage pod of claim 10, wherein said cover is paper that has a wax coating.

19. The beverage pod of claim 10, wherein said bottom wall has a wax coating.

20. The beverage pod of claim 14,
wherein said cover is paper that has a wax coating;
wherein said bottom wall has a wax coating; and
wherein said bottom wall is fused to said sidewall.
